(19) United States
(12) Patent Application Publication
(10) Pub. No.: US 2005/0080710 A1
(43) Pub. Date: Apr. 14, 2005

(54) Method and apparatus for providing trading information

(76) Inventors: Richard A. Malato, Chicago, IL (US); Trevor B. Harnett, Chicago, IL (US); Michael R. Burkhart, Chicago, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/685,228

(22) Filed: Oct. 14, 2003

(51) Int. Cl. G06F 17/60

(52) U.S. Cl. 705/37

(57) ABSTRACT

A method of providing trading market information, including (a) receiving substantially real time trade data for a trade; (b) adding the quantity of the received trade data to generate bid trade volumes and ask trade volumes for the price of the trade; (c) determining whether the price signifies a change in price direction in a series; (d) selectively displaying the generated bid trade volumes and ask trade volumes in a row of a column, the row corresponding to the price of the trade and the column corresponding to a series of trades. If a change in price direction in a series is determined in step (c), the bid trade volumes and ask trade volumes are displayed as a new series in a new column. The steps are repeated with new trade data. Price deltas consisting of ask trade volumes minus bid trade volumes for each price are continuously generated and selectively displayed. A total delta comprising the sum of the price deltas is also displayed. An apparatus having a display monitor and processor function according to the method.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention is directed toward an apparatus and method for providing trading information, and particularly toward an apparatus and method for providing trading information for user controlled electronic trading.

### BACKGROUND OF THE INVENTION AND TECHNICAL PROBLEMS POSED BY THE PRIOR ART

Trading of various products is well known. Fundamentally, a seller offers a product for sale at a specified price, or a buyer offers to buy a product at a specified price, and a transaction or trade occurs when another party accepts the offer.

For products such as futures, stocks, derivatives and the like, markets such as stock exchanges and commodities exchanges have long been used to facilitate trading. For a long time, such markets operated under an old method known as bazaar, in which people gathered together to search out others desiring to trade in like products, whether to buy or sell or both, in an open outcry auction. Typically, such open outcry auctions have taken place in “pits” in which buyers and sellers (or their representatives) of like products physically gather together and, via open outcry, vocally and/or demonstrably indicate open offers which others in the pit may accept to generate a trade of the product.

More recently, however, open outcry pit trading has begun to be replaced by electronic trading, in which the traders do not physically gather together but instead monitor offers and make trades based on such offers by viewing streams of related data electronically. However, while electronic trading has definite benefits, it also has not provided the feelings, senses and memories which are provided in pit trading and which have been integral factors to the success of pit traders. Electronic trading has, for experienced pit traders particularly, deprived them of the advantages which they previously had in witnessing and processing the effects of each trade on others and how the market reacts to fluctuating price and volume.

The present invention is directed toward overcoming one or more of the problems set forth above.

### SUMMARY OF THE INVENTION

In one aspect of the present invention, a method of providing trading market information is provided, including (a) receiving substantially real time trade data for a trade, the trade data including quantity, price, and bid/ask indication; (b) adding the quantity of the received trade data to generate bid trade volumes and ask trade volumes for the price of the trade; (c) determining whether the price signifies a change in price direction in a series; (d) selectively displaying the generated bid trade volumes and ask trade volumes in a row of a column, the row corresponding to the price of the trade and the column corresponding to a series of trades, wherein if a change in price direction in a series is determined in step (c), the bid trade volumes and ask trade volumes are displayed as a new series in a new column; and (e) repeating steps (a) through (d) for the next received trade data.

In one form of this aspect of the invention, selectively displaying the bid trade volumes and the ask trade volumes includes selectively displaying a price delta comprising ask trade volumes minus bid trade volumes.

In another form of this aspect of the invention, selectively displaying the bid trade volumes and the ask trade volumes includes selectively displaying the ask trade volumes on one side of the column and the bid trade volumes on the other side of the column, with a separator displayed therebetween.

In still another form of this aspect of the invention, if a change in price direction is determined in step (d), the new column is displayed where the column for the immediately previously generated ask trade volumes and bid trade volumes were displayed, and the previously displayed columns are shifted horizontally one column.

In yet another form of this aspect of the invention, selectively displaying the generated bid trade volumes and ask trade volumes comprises selectively displaying the total trade volumes. In further forms, each row in each column comprises a cell, and the selectively displaying step (c) further comprises shading each of the cells based on total volume displayed in the cells, and darker shades correspond to higher total volumes.

In another form, each row in each column comprises a cell, and the method further includes the steps of generating price deltas comprising ask trade volumes minus bid trade volumes for each price of each series, and displaying each cell having a positive price delta in a first color and displaying each cell having a negative price delta in a second color, the second color being different from the first color. In a further form, the second color is red. In a still further form, the selectively displaying step (c) further comprises shading each of the cells based on the absolute value of the price delta for each cell.

In still another form, consecutive price series are alternately designated as up and down price series, and a change in price direction in a series is determined in step (d) when it is determined that the price of the last received trade data is either (I) at least two price levels below the price level of the highest trade price in an up price series, or (ii) at least two price levels above the lowest trade price in a down price series.

In yet another form, price deltas consisting of ask trade volumes minus bid trade volumes for each price are continuously generated and selectively displayed. In a further form, a total delta comprising the sum of the price deltas is periodically generated and selectively displayed.

In another aspect of the present invention, a method of providing trading market information is provided, including (a) receiving substantially real time trade data for a trade, the trade data including price and bid/ask indication; (b) adding the received trade data to generate bid trade counts and ask trade counts for the price of the trade; (c) determining whether the price signifies a change in price direction in a series; (d) selectively displaying the generated bid trade counts and ask trade counts in a row of a column, the row corresponding to the price of the trade and the column corresponding to a series of trades, wherein if a change in price direction in a series is determined in step (c), the bid trade counts and ask trade counts are displayed as a new series in a new column; and (e) repeating steps (a) through (d) for the next received trade data.

In yet another aspect of the present invention, a method of providing trading market information is provided, including (a) continuously receiving trade data, the trade data for each trade including quantity, price, and bid/ask indication; (b) beginning at a selected time, continuously adding the quantity of the received trade data to generate bid trade volumes and ask trade volumes for each price for all trades since the selected time; (c) continuously updating price deltas comprising ask trade volumes minus bid trade volumes for each price; (d) periodically generating a total delta comprising the sum of the price deltas; and (e) selectively continuously displaying current ones of the price deltas and total delta.

In an advantageous form of this aspect of the invention, the displaying step includes displaying price deltas in a series of cells in a column, wherein each cell corresponds to a different price.

In still another aspect of the present invention, a method of providing trading market information is provided, including (a) continuously receiving a substantially real time stream of trade data, the trade data for each trade including quantity, price, and bid/ask indication; (b) beginning at a selected time, continuously adding the quantity of the received trade data substantially as received to generate bid trade volumes and ask trade volumes for each price for all trades since the selected time; (c) continuously updating price deltas comprising ask trade volumes minus bid trade volumes for each price; (d) periodically generating a total delta comprising the sum of the price deltas; and (e) selectively continuously displaying current selected ones of the bid trade volumes, ask trade volumes, price deltas and total delta.

In yet another aspect of the present invention, an apparatus for providing trading market information includes a display monitor and a processing unit. The processing unit has an input port adapted to receive substantially real time trade data for a trade, the trade data including quantity, price, and bid/ask indication, and an output port connected to the monitor for displaying information. Further, the processing unit (a) adds the quantity of the received trade data to generate bid trade volumes and ask trade volumes for the price of the trade, (b) determines whether the price signifies a change in price direction in a series, (c) selectively generates for output through the output port a display signal for the monitor, the display signal displaying the generated bid trade volumes and ask trade volumes in a row of a column, the row corresponding to the price of the trade and the column corresponding to a series of trades, wherein if a change in price direction in a series is determined, the display signal displays the bid trade volumes and ask trade volumes as a new series in a new column, and (d) continuously updates processes (a) through (c) as new trade data is received via the input port.

In one advantageous form of this aspect of the present invention, a user input to the processor is adapted to allow user selection of parameters for the display signal. In further advantageous forms, the parameters include volume thresholds, change in price direction indicators, and the mode of displaying the bid trade volumes and ask trade volumes. In a further form, the displaying mode includes at least two of bid trade volumes and ask trade volumes on opposite sides of a separator, ask trade volumes minus bid trade volumes, ask trade volumes plus bid trade volumes, and bid trade counts and ask trade counts on opposite sides of a separator.

### BRIEF DESCRIPTION OF THE DRAWINGS

FIG. 1 is a representation of the processing and displaying apparatus according to the present invention;

FIG. 2 is an example display of trading information in accordance with the present invention;

FIG. 3 is a flow chart illustrating the method according to the present invention;

FIGS. 4a-c are example displays of footprint trading information according to the present invention, where:

FIG. 4a illustrates the footprint with both bid trade volumes and ask trade volumes;

FIG. 4b illustrates the footprint with total volumes;

FIG. 4c illustrates the footprint with deltas;

FIG. 5 is another example display of footprint trading information according to the present invention; and

FIG. 6 is yet another example display of footprint trading information, showing the use of only color and shade to convey information according to the present invention.

### DETAILED DESCRIPTION OF THE INVENTION

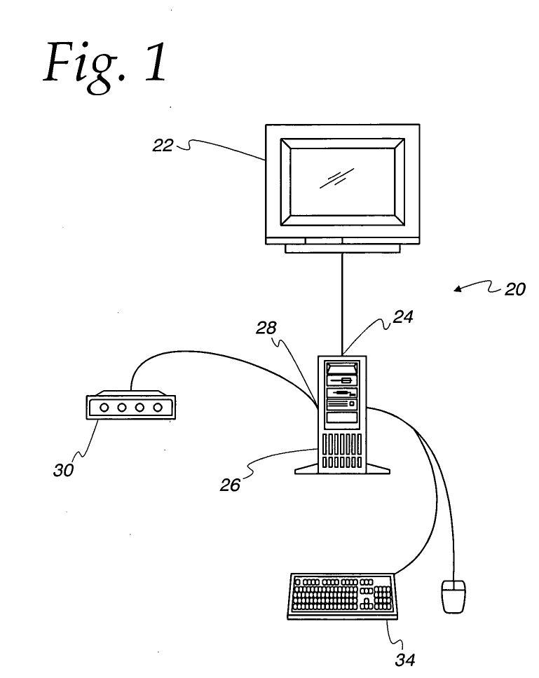

An apparatus 20 in accordance with the present invention is illustrated in FIG. 1. The apparatus 20 includes a suitable display, such as a display monitor 22 connected to a display output port 24 of a suitable processor 26. The processor 26 also includes an input port 28 through which trade data from a suitable source 30 may be continuously received, preferably in substantially real time as trades occur. (“Continuously” as used herein means updating information substantially each time new trade data is received. However, it should be recognized that volumes of separate similar trades occurring at substantially the same time may also be aggregated and treated as a single trade with a volume equal to the combined volume of the separate trades, such that receipt of that combined trade data would also be considered to be “continuous.) The source 30 may, for example, be a service available over an internal or external network (such as the Internet and World Wide Web) having access to trade information from the market where trading of the product of interest occurs.

A suitable user input 34, such as a keyboard and/or mouse/pointing device, is also advantageously provided with the apparatus 20. The user input 34 may be advantageously used by a user to specify particular details and formats of display of trade information on the monitor 22.

Received trade data preferably consists of the following elements of information:

PRICE: This is the price at which the trade occurred.

BID/ASK INDICATION: This is an indication of whether the trade occurred as a result of a seller's offer to sell (ASK) or a buyer's offer to buy (BID).

VOLUME: This is the number of units sold in the trade (e.g., number of futures contracts or 100's of shares of stock).

Time may also be included for each trade as appropriate, though if the stream of trade data is received in substantially real time and in sequential order based on the actual time of the trade, it would be within the scope of the present invention to omit time element from the trade data and simply use the time of receipt of the trade data as the essential time of the trade. It is significant, and should be recognized, that the data which is used is of actual trades which have occurred, and not merely of offers to buy or sell products.

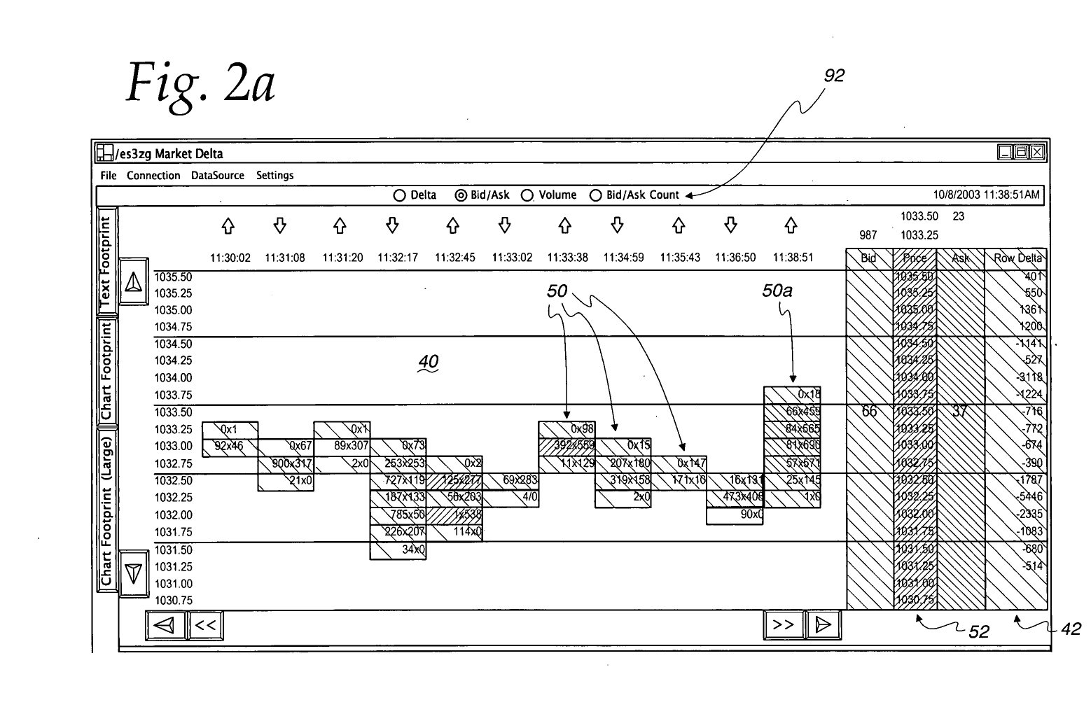

The processor 26 receives the trade data and processes it, as described in greater detail below, to generate a suitable display signal so that the processed trade information may be displayed in an advantageous format such as shown in FIG. 2. It will particularly be appreciated by experienced pit traders that the information displayed in FIG. 2 will readily provide a user with substantially the same feelings, senses and memories which experienced traders advantageously used to succeed in pit trading, but which has been heretofore lacking in electronic trading.

As illustrated in FIG. 2, the trade data may be used to generate display of, inter alia, a footprint 40, row or daily price deltas 42, and a daily delta 44.

The footprint 40 includes a sequential series of columns where each column consists of a series of trades, the current series of trades being on the right with previous series of trades moving to the left as each new series is created. Each series consists of a column of cells 50, with each cell corresponding to a price level as illustrated at 52. The display of this footprint 40 is described in greater detail hereafter.

The daily price deltas 42 consist of a column of numbers, each number corresponding to a price level. For advantageous display, the price levels of the daily price deltas 42 may be aligned with the price levels 52 of the footprint 40. The price deltas are calculated for each price level, with the price delta for each price level being equal to the ask trade volume minus the bid trade volume (i.e., the total units traded as a result of acceptance of an ask offer to sell at that price level minus the total units traded as a result of acceptance of a bid offer to buy at that price level). The daily price deltas 42 are based on an accumulation of trades over a selected period of time, such as the current trading day. A user may however select a different period of time over which to calculate daily price deltas 42 (e.g., calculate price deltas based on trades in the last hour, two hours, etc.).

The daily delta 44 is a single number which is the sum of the daily price deltas 42 for the day (although it too may be calculated to cover a different time period if desired by the user). The high and low deltas 53, 54 may also be displayed to give an indication of the current daily delta 44 relative to its value throughout the day. Very broadly speaking, in a sellers' market (where more units are being traded as a result of the sellers' price being accepted), delta will be positive, whereas in a buyers' market (where more units are being traded as a result of the buyers' price being accepted), delta will be negative.

A temporal indication of the daily delta 44 may also be advantageously provided graphically, as by a three-axis chart 56, with the trade price over the selected period of time shown in a line graph 57 (relative to the vertical axis on the right) and the range of the daily delta (relative to the vertical axis on the left) during selected time segments over that same selected period of time shown by bar graphs 58 or other suitable graph form.

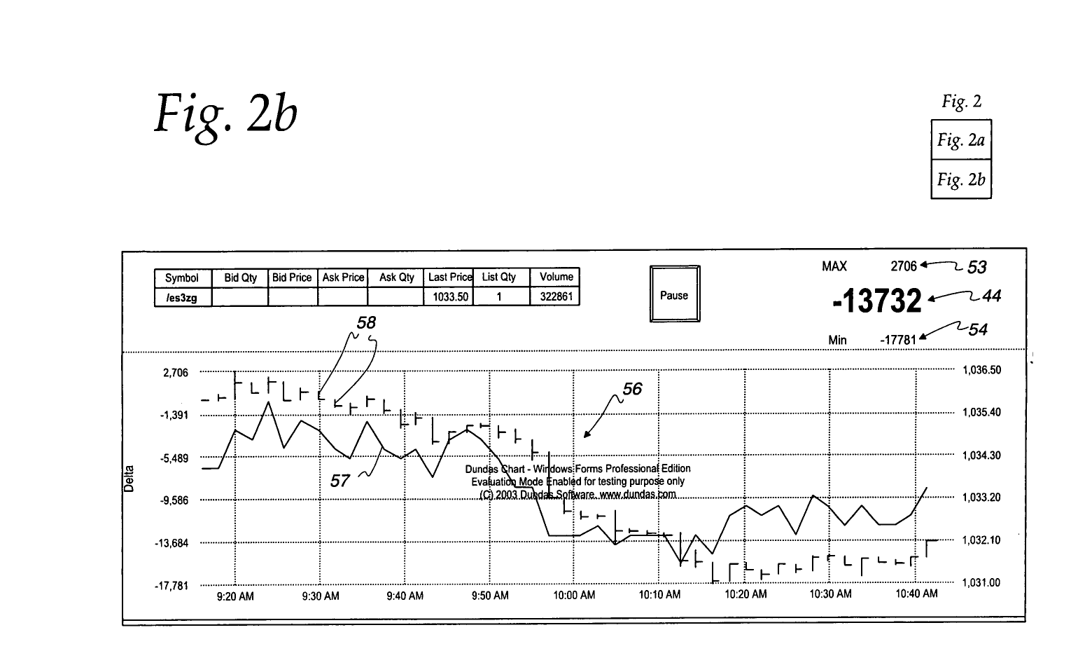

The method of handling and advantageously displaying the trade data is illustrated in FIG. 3.

Trade data is continuously received at box 60. As data for a trade is received, may be first checked at box 62 to see whether or not the trade was at a price which was less than two levels from the displayed maximum or minimum price 52. If it is, then the displayed price levels 52 will be shifted appropriately (along with the footprint 40 and daily price deltas 42) at box 64 to ensure that the current trading price will be among those displayed (i.e., to ensure that the latest data does not move off of the displayed chart).

The price of the trade data is also checked at box 66 to see if it indicates a change in price direction for the current-series. A change in price direction can be determined in any suitable manner, including using parameters which the user selects. For example, when the price series 50a is up, a trade which occurs at a price which is at least two levels below the high price in the series 50a could be considered to be a change in price direction. If the user did not want such a sensitivity to change, however, the user could require that the price be at least three (or more) levels below the high price. In the illustrated example, the price levels are every $0.25. If the market is such as to accept intermediate price levels, however (e.g., every $0.05), a similar sensitivity to the “two level” price would be ten levels. Conversely, if the series is down, then a price direction change could be detected when a trade occurs which is at least two price levels above the lowest price level in the series. (It should also be recognized that while specific gradients of price levels are used [e.g., every $0.25 in FIG. 2], where the markets trade at infinite price variations, price levels may be defined as ranges within the scope of the present invention. In that case, for example, price level of $1025.25 and $1025.50 could be defined as encompassing any sales from $1025.13 to $1025.37 and $1025.38 to $1025.63, respectively.)

For example, in FIG. 2, the current series 50a is an up series. At the moment illustrated, if the next price at which a trade occurs is $1033.25 (or lower), then a new series would start, since $1033.25 is two levels below $1033.75 (the highest trade price for that series). If, however, the next trade which occurs at a price other than $1033.75 or $1033.50 is $1034.00, then the up series would be viewed as continuing. Thereafter, any trade which occurred at $1033.50 (the second price level below the new high, $1034.00) would be viewed as a change in price direction, in which case a new current series would be created.

When a price direction change is detected at box 66, the series 50 are shifted to the left (box 70), the new series up/down designation is changed (box 72), and a new series is created (box 74) and displayed at 50a. In this manner, the sequence of most recent series will be displayed in the footprint 40, with the oldest of the series shifting off of the display each time a new series is created.

The designation of a series as up/down may be accomplished in any suitable manner. In one advantageous manner, the initial series during a monitored period may be suitably designated as up or down, whether randomly or as a result of, for example, whether the first price change from the price of the initial change is up or down. Thereafter, each series may simply be alternately designated as indicated at box 72 (so that consecutive series are simply changed from up to down designations, and vice versa), with change in price direction change being determined based on the series designation (i.e., in a “down” series, look for a trade at two price levels above the minimum in the series, and in an “up” series, look for a trade at two price levels below the maximum in the series).

Continuing with the method in FIG. 3, whether or not a new series is created, at box 80 the volume of the trade is added, at the price level of the trade, to the total trade volume for the current series 50a in footprint 40 and the daily total for inclusion in the daily price delta 42. That is, the volume is added to the previous total volume of bid or ask trades (based on whether the trade was a bid trade or an ask trade) which have occurred in the relevant time period (since the last change in price direction for the current series 50a, and since the beginning of the day for the daily price delta 42).

The accumulated volumes of bid/ask trades at each price level are then used at box 82 to generate the daily price delta 42 and the delta for the current series 50a (with each delta being the volume of ask trades minus the volume of bid trades at the trade price in the series). The daily delta 44 may then be generated at box 84 (the daily delta 44 being simply the sum of the daily price deltas 42), and the daily price deltas 42 associated with the prices fitting within the displayed range and the daily delta 44 are then displayed at box 86 (such as seen in FIG. 2). At box 90, bid/ask volumes for the current series 50a are also displayed in the footprint 40.

It should be appreciated that many of the above described steps may occur simultaneously rather than sequentially. Further, it should be appreciated that many of the calculations may occur only where relevant, without being needlessly repeated (e.g., daily price deltas 42 may be stored in registers as they are accumulated throughout the day, with only the daily price delta 42 associated with the new trade recalculated when new trade data is received). All such variations would be within the scope of the present invention. Still further, since data is continuously received at box 60 as previously indicated, it should be appreciated that the previously described steps will also continuously occur, with the various displays of information thereby being similarly continuously updated.

Referring again to box 90, the bid/ask volumes may be advantageously displayed in each cell with the bid trade volume on the left separated by a suitable visual separator (such as “x”) from the ask trade volume on the right. In the sample illustrated in FIG. 2, the bottom cell of the current series indicates that since 11:36:50 (the time of the last trade in the previous series) up to 11:38:51 (the time of the latest trade in the current series), no (0) units have been sold at the ask price of $1032.25 (i.e., if a seller has offered to sell at $1032.25 [which may or may not have occurred], no one has accepted any such offers) and one (1) unit has been sold at the bid price of $1032.25 (ie., as a result of acceptance of a buyer's offer to buy at $1032.25).

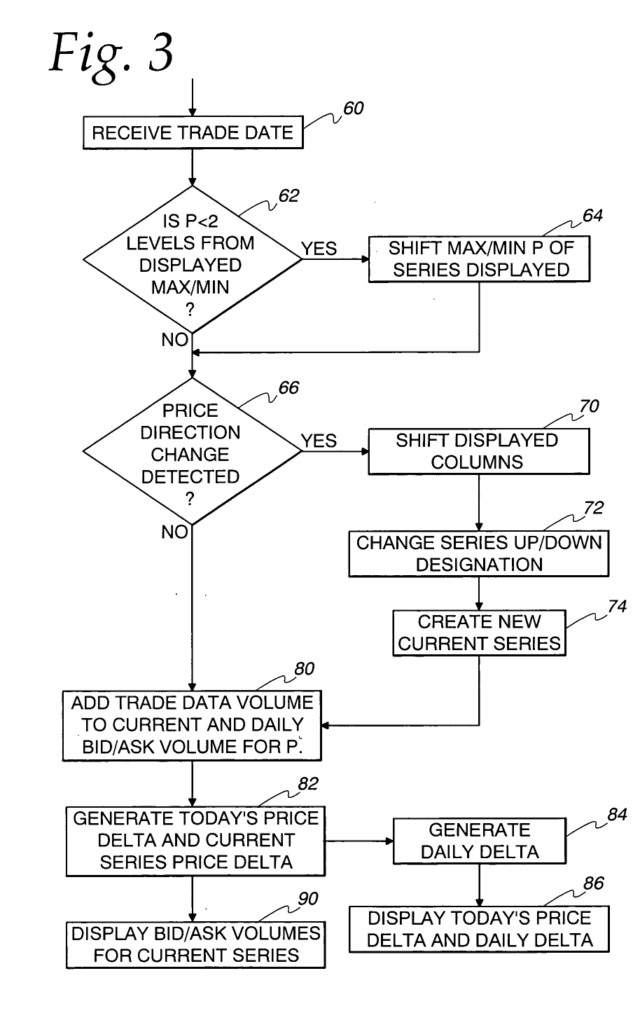

It should be appreciated, however, the bid/ask volumes and/or bid/ask counts (as discussed below) in the footprint 40 may be advantageously displayed in a variety of ways, which may be selected by the user based upon their own preference. In FIG. 2, the bid volumes and ask volumes are directly displayed as described above. FIGS. 4a illustrates in simplified form such a direct display, with just the latest trade volumes listed under “bid” and “ask” for purposes of explanation. Prior to these trades, in the current series 50a, 2 units had been traded at a bid price of $991.00 and 4 units had been traded at an ask price of $991.25. As another example, three series before the current series, 5 units had been traded at a bid price of $991.75 and 8 units had been traded at an ask price of $991.75.

This same trade data is illustrated in FIG. 4b, wherein the bid/ask volumes are shown indirectly as simply the sum of both volumes. Thus, in the current series 50a, the trade of 5 units at the bid price and 4 units at the ask price of $991.00 is represented simply as the trade of 9 units.

FIG. 4c similarly illustrates the same trade data, with the bid/ask volumes shown indirectly as the delta (i.e., ask trade volume minus bid trade volume). Thus, in the current series 50a, the trade of 5 units at the bid price and 4 units at the ask price of $991.00 is represented simply as a delta of “−1” (4−5). Again, with all of the present invention, it should be recognized that “delta” is a unique indicator which will assist traders in providing substantially the same feelings, senses and memories which experienced traders advantageously used to succeed in pit trading, but which has been heretofore lacking in electronic trading.

Additionally, trade data can be displayed in the footprint 40 by showing the number of trades at bid or at ask (“bid/ask count”) independent of volume. It can be helpful to know, via such a display, whether a large volume of units traded at a given price occurred due to a few large trades or a large number of smaller volume trades, and a display of bid trades-separator-ask trades (e.g., 4×10 for four bid trades and ten ask trades) can be informative to a trader, particularly when made in conjunction with colors and/or shading as further described below.

It should be appreciated that the selection of the mode of display of bid/ask volumes such as variously illustrated in FIGS. 4a-4c may be selected by the user via use of the user input 34. For example, interactive elements 92 (see FIG. 2) may be provided on the display such as is well known in computer technology allowing the user to easily (with use of a mouse and cursor) select which type of display he or she desires at that particular time.

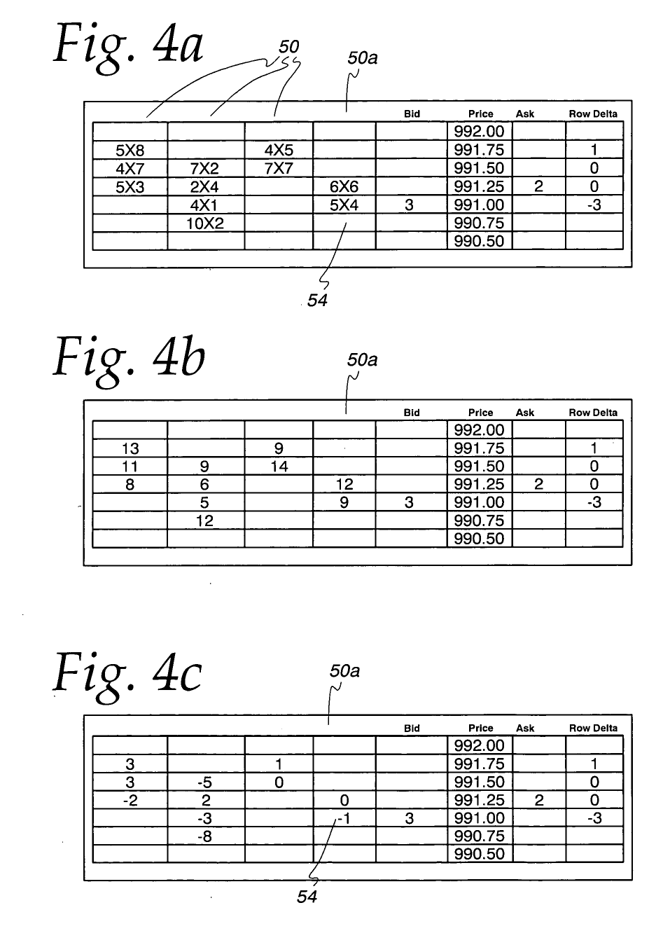

FIG. 5 further illustrates an advantageous manner of displaying the footprint, with colors and shading used to provide still further users with the desired feel, senses and memories at a quick glance. For convenience of reference in identifying individual cells, the columns and rows of the illustration have been identified by letters and numbers.

Specifically, in the advantageous format illustrated in FIG. 5, the individual cells of the footprint 40 may be shaded between different levels of darkness to indicate total volume of trades, and the color of each cell is chosen to the delta for the trades which are represented in the cell. For example, the cells in which there is a positive delta may be illustrated in a positive color (such as blue or green) whereas the cells in which there is a negative delta may be illustrated in a negative color (such as red). A white cell is used where delta is zero (though a default selection of one color or the other can be used if desired). Thus, in the illustrated data, cells A2 (5×8), A3 (4×7), B4 (2×4), C2 (2×8), D1 (0×10), D2 (2×9), D3 (4×10), D4 (2×5) and D5 (3×6) are blue, whereas cells A4 (5×3), B3 (7×2), B5 (4×1), B6 (10×2), C5 (7×2), C6 (8×2) C7 (10×0) and D6 (5×2) are red. Those with higher volumes (e.g., greater than 10 units) may be advantageously illustrated in darker shaded cells. However, it should be recognized that various combinations of two or more colors and/or shades may be advantageously used to provide an individual user with their own desired feel. For example, some traders may be more successful in a down market, in which case they may choose to have negative delta cells illustrated in a positive color.

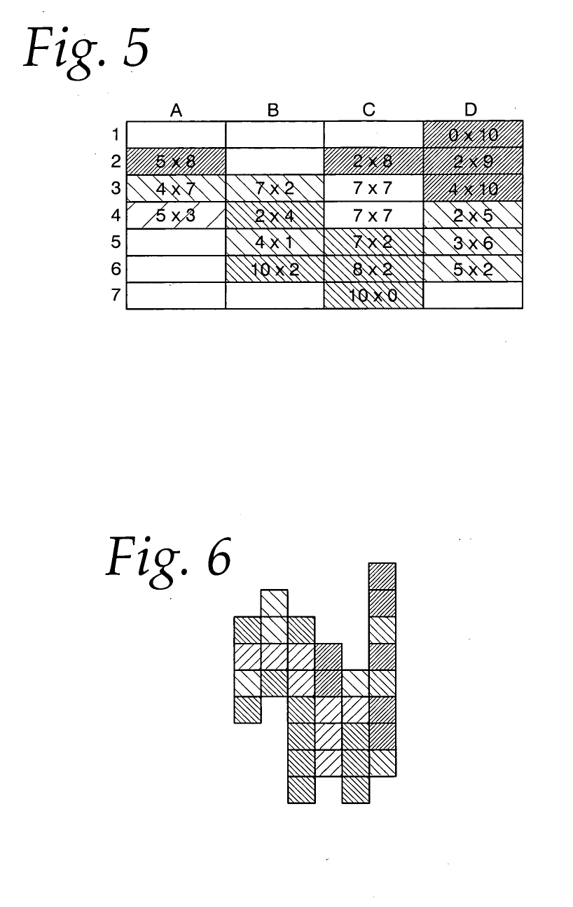

As illustrated in FIG. 6, the illustration of the bid/ask volumes may even be advantageously displayed without any text, through use of colors and shades alone to provide indications of total volumes and delta in a compact space.

It should be appreciated that the apparatus and method according to the present invention will assist traders in providing substantially the same feelings, senses and memories which were available in pit trading, but which has been heretofore lacking in electronic trading. Moreover, it should be appreciated that individual users may readily adapt the present invention to their own characteristics to provide such feelings, senses and memories as each individual user may desire.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A method of providing trading market information, comprising:
(a) receiving substantially real time trade data for a trade, said trade data including quantity, price, and bid/ask indication;
(b) adding said quantity of said received trade data to generate bid trade volumes and ask trade volumes for the price of said trade;
(c) determining whether said price signifies a change in price direction in a series;
(d) selectively displaying said generated bid trade volumes and ask trade volumes in a row of a column, said row corresponding to said price of said trade and said column corresponding to a series of trades, wherein if a change in price direction in a series is determined in step (c), said bid trade volumes and ask trade volumes are displayed as a new series in a new column; and
(e) repeating steps (a) through (d) for the next received trade data.

2. The method of claim 1, wherein selectively displaying said bid trade volumes and said ask trade volumes comprises selectively displaying a price delta comprising ask trade volumes minus bid trade volumes.

3. The method of claim 1, wherein selectively displaying said bid trade volumes and said ask trade volumes comprises selectively displaying said ask trade volumes on one side of said column and said bid trade volumes on the other side of said column, with a separator displayed therebetween.

4. The method of claim 1, wherein when a change in price direction is determined in step (d), said new column is displayed where the column for the immediately previously generated ask trade volumes and bid trade volumes were displayed, and the previously displayed columns are shifted horizontally one column.

5. The method of claim 1, wherein said selectively displaying said generated bid trade volumes and ask trade volumes comprises selectively displaying the total trade volumes.

6. The method of claim 5, wherein each row in each column comprises a cell, and said selectively displaying step (c) further comprises shading each of said cells based on total volume displayed in said cells.

7. The method of claim 6, wherein darker shades correspond to higher total volumes.

8. The method of claim 1, wherein each row in each column comprises a cell, and further comprising the steps of:
generating price deltas comprising ask trade volumes minus bid trade volumes for each price of each series; and
displaying each cell having a positive price delta in a first color and displaying each cell having a negative price delta in a second color, said second color being different from said first color.

9. The method of claim 8, wherein said second color is red.

10. The method of claim 8, wherein said selectively displaying step (c) further comprises shading each of said cells based on the absolute value of said price delta for each cell.

11. The method of claim 1, wherein consecutive price series are alternately designated as up and down price series, and a change in price direction in a series is determined in step (d) when it is determined that the price of the last received trade data is either (I) at least two price levels below the price level of the highest trade price in an up price series, or (ii) at least two price levels above the lowest trade price in a down price series.

12. The method of claim 1, further comprising the steps of:
continuously generating price deltas comprising ask trade volumes minus bid trade volumes for each price; and
selectively displaying the current price deltas.

13. The method of claim 12, further comprising the steps of:
periodically generating a total delta comprising the sum of the price deltas; and
selectively displaying the current total delta.

14. A method of providing trading market information, comprising:
(a) receiving substantially real time trade data for a trade, said trade data including price and bid/ask indication;
(b) adding said received trade data to generate bid trade counts and ask trade counts for the price of said trade;
(c) determining whether said price signifies a change in price direction in a series;
(d) selectively displaying said generated bid trade counts and ask trade counts in a row of a column, said row corresponding to said price of said trade and said column corresponding to a series of trades, wherein if a change in price direction in a series is determined in step (c), said bid trade counts and ask trade counts are displayed as a new series in a new column; and
(e) repeating steps (a) through (d) for the next received trade data.

15. A method of providing trading market information, comprising:
continuously receiving trade data, said trade data for each trade including quantity, price, and bid/ask indication;
beginning at a selected time, continuously adding said quantity of said received trade data to generate bid trade volumes and ask trade volumes for each price for all trades since said selected time;
continuously updating price deltas comprising ask trade volumes minus bid trade volumes for each price;
periodically generating a total delta comprising the sum of the price deltas; and
selectively continuously displaying current ones of said price deltas and total delta.

16. The method of claim 15, wherein said displaying step includes displaying price deltas in a series of cells in a column, wherein each cell corresponds to a different price.

17. A method of providing trading market information, comprising:
continuously receiving a substantially real time stream of trade data, said trade data for each trade including quantity, price, and bid/ask indication;
beginning at a selected time, continuously adding said quantity of said received trade data substantially as received to generate bid trade volumes and ask trade volumes for each price for all trades since said selected time;
continuously updating price deltas comprising ask trade volumes minus bid trade volumes for each price;
periodically generating a total delta comprising the sum of the price deltas; and
selectively continuously displaying current selected ones of said bid trade volumes, ask trade volumes, price deltas and total delta.

18. An apparatus for providing trading market information, comprising:
a display monitor;
a processing unit having
an input port adapted to receive substantially real time trade data for a trade, said trade data including quantity, price, and bid/ask indication, and
an output port connected to said monitor for displaying information, wherein said processing unit:
(a) adds said quantity of said received trade data to generate bid trade volumes and ask trade volumes for the price of said trade,
(b) determines whether said price signifies a change in price direction in a series,
(c) selectively generates for output through said output port a display signal for said monitor, said display signal displaying said generated bid trade volumes and ask trade volumes in a rows of a column, said row corresponding to said price of said trade and said column corresponding to a series of trades, wherein if a change in price direction in a series is determined, said display signal displays said bid trade volumes and ask trade volumes as a new series in a new column, and
(d) continuously updates processes (a) through (c) as new trade data is received via said input port.

19. The apparatus of claim 18, further comprising a user input to said processor adapted to allow user selection of parameters for said display signal.

20. The apparatus of claim 19, wherein said parameters include volume thresholds.

21. The apparatus of claim 19, wherein said parameters include change in price direction indicators.

22. The apparatus of claim 19, wherein said parameters include the mode of displaying said bid trade volumes and ask trade volumes.

23. The apparatus of claim 22,.wherein said displaying mode includes at least two of bid trade volumes and ask trade volumes on opposite sides of a separator, ask trade volumes minus bid trade volumes, ask trade volumes plus bid trade volumes, and bid trade counts and ask trade counts on opposite sides of a separator.
